(19) United States
(12) Patent Application Publication
(10) Pub. No.: US 2015/0193880 A1
(43) Pub. Date: Jul. 9, 2015

(54) Revenue Generating Method

(71) Applicant: Mark Anthony Parmer, Tyler, TX (US)

(72) Inventor: Mark Anthony Parmer, Tyler, TX (US)

(21) Appl. No.: 14/592,868

(22) Filed: Jan. 8, 2015

Related U.S. Application Data
(60) Provisional application No. 61/924,930, filed on Jan. 8, 2014.

(51) Int. Cl. G06Q 40/06

(52) U.S. Cl. CPC G06Q 40/06

(57) ABSTRACT

A method of generating revenue by investing in intellectual property. In one embodiment, one or more investors invests in an invention. The investors may work in conjunction with a company that can provide one or more representatives that can assist the investors with various aspects of their investment. For example, the representatives may assist the investors with improving and developing an invention, manufacturing, distributing, marketing, selling the invention, and the like. The investors can vote by proxy with a NAND gate system in order to make decisions throughout the investment process. The investment is continually monitored to determine gains and losses.

### CROSS REFERENCE TO RELATED APPLICATION

This application claims the benefit of U.S. Provisional Application No. 61/924,930 filed on Jan. 8, 2014. The above identified patent application is herein incorporated by reference in its entirety to provide continuity of disclosure.

### FIELD OF THE INVENTION

The present invention relates to a method for generating revenue. More specifically, the present invention pertains to an improved method of generating revenue by investing in intellectual property. In one embodiment, the method involves the step of one or more investors working with a company that can provide one or more representatives to assist the investors, whereby each decision is made by a vote using a NAND gate system.

### BACKGROUND OF THE INVENTION

Intellectual property can consist of patents, trade secrets, copyrights, and trademarks. Intellectual property is frequently the most important asset of many startup businesses as well as inventors and corporations. Extracting value from intellectual property and preventing others from deriving value from it is an important responsibility for these business. Many businesses, however, do not have sufficient financial means and resources to protect and/or further develop its intellectual property and related assets. Thus, businesses continually seek investors to provide such financial means and resources.

Additional financial means and resources can be used to conduct further research and development of intellectual property. Additionally, resources can be used for manufacturing and marketing. There are many investors having interests in providing financial means and resources. These investors, however, often lack expertise and proper guidance to assist businesses with protecting and/or developing their intellectual property in order to make successful investments. Thus, there is an increasing need for a method that assists startup businesses and investors to improve the method of investing in intellectual property.

### DESCRIPTION OF THE PRIOR ART

Methods have been disclosed in the prior art that claim methods of investing in intellectual property. These include methods that have been patented and published in patent application publications. Some of these methods disclose the steps of investing in an idea or an invention, providing online and trade show promotions, and pairing inventors with a company. These methods, however, do not disclose the steps of improving the invention, negotiating funding, and assisting with manufacturing. The foregoing is a list of prior art references deemed most relevant to the present disclosure, which are herein described for the purposes of highlighting and differentiating the unique aspects of the present invention, and further highlighting the drawbacks existing in the prior art.

Specifically, U.S. Patent Application Publication Number 2013/0060715 to Kil discloses a method for supporting intellectual property commercialization. The method comprises the steps of providing a project information, processing investment of knowledge-based service, assessing current value of project, managing shares, assessing value of invested service, processing share trading and/or converting mileage point, and computing dividend. Kil, however, does not disclose steps of investors working with a company to improve an invention, negotiate funding, and assist with manufacturing.

Similarly, U.S. Pat. No. 7,720,740 to Jones discloses a system of fractional ownership of intellectual property. The system comprises a pooling account, a first entity, and at least one secondary entity. The first entity can have an interest in an intellectual property, and can transfer at least a portion of such interest into the pooling account. The second entity can contribute consideration into the pooling account. In return for the consideration from the second entity, a commensurate fractional interest in the intellectual property can be associated with the second entity. Jones, however, does not disclose one or more investors working in conjunction with a company.

U.S. Patent Application Publication Number 2001/0034695 to Wilkinson discloses a method for facilitating tangible valuation of intellectual property assets. The method comprises the step of providing a centralized intellectual property market. The market is accessible to individuals having an interest in at least one intellectual property asset. The asset can be exchanged for a tangible value so as to provide a valuation. In contrast, the present invention provides the steps of improving the invention, negotiating funding, and assisting with manufacturing prior to determining a tangible valuation of intellectual property assets.

U.S. Patent Application Publication Number 2013/0041803 to Henning discloses a method for aggregating and valuing intellectual property. In one embodiment, holders of intellectual property rights may sell, or license intellectual property to an aggregator and receive shares of stock or cash from the contribution based on the aggregated value of the intellectual property held by the aggregator. Henning, however, does not disclose the steps of investors working in conjunction with a company and/or one or more representatives.

U.S. Patent Application Publication Number 2002/0099637 to Wilkinson discloses intellectual property investment process. The process is divided into four phases: accounting; valuation; analysis; and investment management. The accounting phase comprises the steps of identifying intellectual property assets and recording it to an inventory. The valuation phase comprises the steps of determining validity of intellectual property assets, computing assets, and establishing a fair market value. The analysis phase comprises the steps of computing valuation of intellectual property assets to make financial transaction recommendations. The investment management step comprises the steps of determining investment strategy, conducting financial transactions, and monitoring performance of the investments. Wilkinson, however, does not disclose the steps of developing an invention.

Finally, U.S. Patent Application Publication Number 2002/0087448 to Wilkinson discloses a method for commercialization of intellectual property comprising the steps of providing a centralized network of service provider members, offering an interested party access to the network, and one or more network members providing services to the interested party. The market also comprises the steps of creating a financial market for intellectual property assets, where the assets can be bought and sold. Wilkinson, however, does not disclose a voting system comprising a NAND gate.

The methods disclosed in the prior art have several known drawbacks. Particularly, none of the methods in the prior art pairs investors with a sponsoring company that can provide a representative to improve the invention, negotiate funding, and assist with manufacturing, among other things. The present invention overcomes these limitations by disclosing a sponsoring company with a representative that can provide assistance with various aspects of an investment.

It is therefore submitted that the present invention is substantially divergent in design elements from the prior art, and consequently it is clear that there is a need in the art for an improvement to methods of investing in intellectual property. In this regard, the instant invention substantially fulfills these needs.

### SUMMARY OF THE INVENTION

In view of the foregoing disadvantages inherent in the known types of methods of investing in intellectual property now present in the prior art, the present invention provides a new and improved revenue generating method wherein the same can be utilized for investing in intellectual property.

In one embodiment, the present invention provides a method of generating revenue by investing in intellectual property. In one embodiment, one or more investors can make investments on an invention. The investors can work with representatives of a company who can assist with funding, manufacturing, distribution, marketing, and the like. The investors can vote on decisions so that the representatives are prevented from making unilateral decisions.

The investment is earmarked and tracked in an investment account so that gains and losses are easily tracked. In this way, the present invention allows investors to easily determine the amount of taxes owed at the end of each fiscal year. The investment can be subsequently rolled over, reinvested, or borrowed against. Alternatively, the investment can be withdrawn if the losses are great or exceed a predetermined threshold. Thereafter, the withdrawn investment can be traded for stock with equal or less value with growth potential in order to offset the loss. In this way, the withdrawn investment can be later reinvested.

It is therefore an object of the invention to provide a new and improved revenue generating method that has all of the advantages of the prior art and none of the disadvantages.

Another object of the present invention is to provide a new and improved revenue generating method that earmarks the amount of money original invested so as to allow an investor to easily track gains and losses.

Yet another object of the present invention is to provide a new and improved revenue generating method that utilizes a NAND gate system for voting.

Still yet another object of the present invention is to provide a new and improved revenue generating method that allows investors to work in conjunction with inventors and companies.

Yet another object of the present invention is to provide a new and improved revenue generating method that can avoid problems with brokers and auction failures.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a diagram of an exemplary embodiment of the present invention.

FIG. 2 shows a diagram of an exemplary embodiment of the investment process of the present invention.

FIG. 3 shows a second diagram of an exemplary embodiment of the investment process of the present invention.

### DETAILED DESCRIPTION OF THE INVENTION

References are made herein to the attached drawings. Like reference numerals are used throughout the drawings to depict like or similar elements of the revenue generating method. For the purposes of presenting a brief and clear description of the present invention, the preferred embodiment will be discussed as used to invest in intellectual property. The figures are intended for representative purposes only and should not be considered to be limiting in any respect.

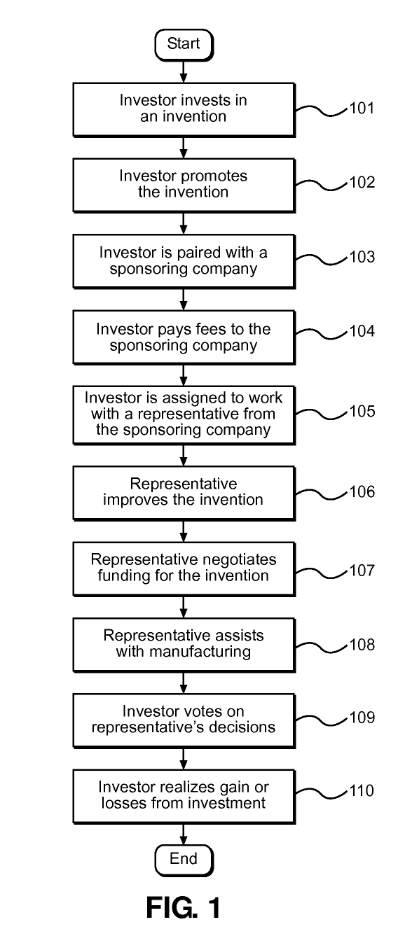

Referring now to FIG. 1, there is shown a diagram of an exemplary embodiment of the present invention. In one embodiment, the present invention comprises the steps of one or more investors investing in an invention 101. It is contemplated that the present invention is used in conjunction with a system comprising a secure database of inventions that are available for investment, wherein the database is accessible by the investors. The investors may be as actively involved as they choose. For example, the investors can promote the invention in various market places, such as in tradeshows or online 102.

If desired, the investors may be paired with a sponsoring company 103 for a fee 104 so that the investors can work in conjunction with the sponsoring company. Investors seeking assistance from a sponsoring company can enter a pool in which sponsoring companies can access. Thereafter, the sponsoring companies can approach the investors who have invested in inventions that peak their interest. Additionally, the sponsoring companies can enter a second pool in which the investors can access. In this way, investors can approach one of the sponsoring companies to obtain their assistance. In some embodiments, the sponsoring companies and the investors may be automatically matched after they each enter their respective pools.

The sponsoring company can provide consultation, research and development, manufacturing, distributing, and/or marketing and sales, manage flow of investment, and funding, among other services. In one embodiment, the sponsoring company can be another investor. Alternatively, the sponsoring company may be the employer of the inventor of the invention, an assignee, or another entity with an interest or rights to the invention. The sponsoring company can provide one or more representatives to assist the investors 105 with various tasks. Without limitation, the representatives can help with improving or finalizing the invention 106, managing funding 107, conducting market studies, conducting tests, and/or assisting with manufacturing 108, distributing, marketing, and sales, among other things.

The investors are given the ability to vote when making decisions 109 at various stages of their investment. It is noted that if one of the investors is the sponsoring company, some or all of the board of directors from the company is given the ability to vote. For example, the investors can vote on how the invention is developed, how it is marketed, and how it is manufactured. Preferably, the voting system of the present invention provides each investor with a voting percentage. The voting percentage depends on the amount of money that the investor has invested. More specifically, it is contemplated that a first investor is given a greater voting percentage than a voting percentage given to a second investor if the first investor has invested a greater amount of money than the second investor.

The voting system of the present invention comprises a NAND gate or similar algorithm. In one embodiment, each investor can vote by proxy with a NAND gate system. The NAND gate system allows up to two inputs per vote. An input for a “yes” vote is given a value of “1” while an input for a “no” vote is given a value of “0.” If one or more both of the inputs include a “yes” vote, the output value of the vote is given a value of “1.” Conversely, if both of the inputs include a “no” vote, the output value of the vote is given a value of “0.” Thus, if the sum of the outputs equals a positive integer, the result of the vote is affirmative or “aye”; and if the sum of the outputs equals zero, the result of the vote is negative or “nay.”

In some embodiments, the present invention may further comprise other factors for use with the NAND gate system. For instance, an input value for each of the voting member present is given a value of “1,” while an input value for each of the voting member absent is given a value of “0.” An input value for gains in the stock market is given a value of “1,” and losses in the stock market is given a value of “0.” Similarly, gains and any positive outcome or progress in the investment is given a value of “1,” while losses and any negative outcome or deterrence in the investment is given a value of “0.” Finally, any pretax savings is given a value of “0” while after tax savings is given a value of “1.”

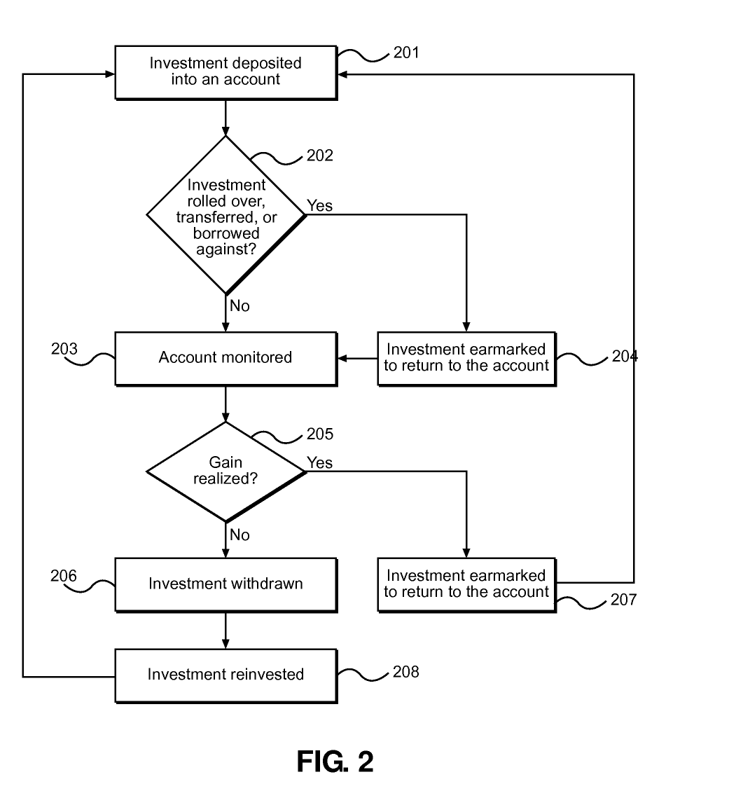

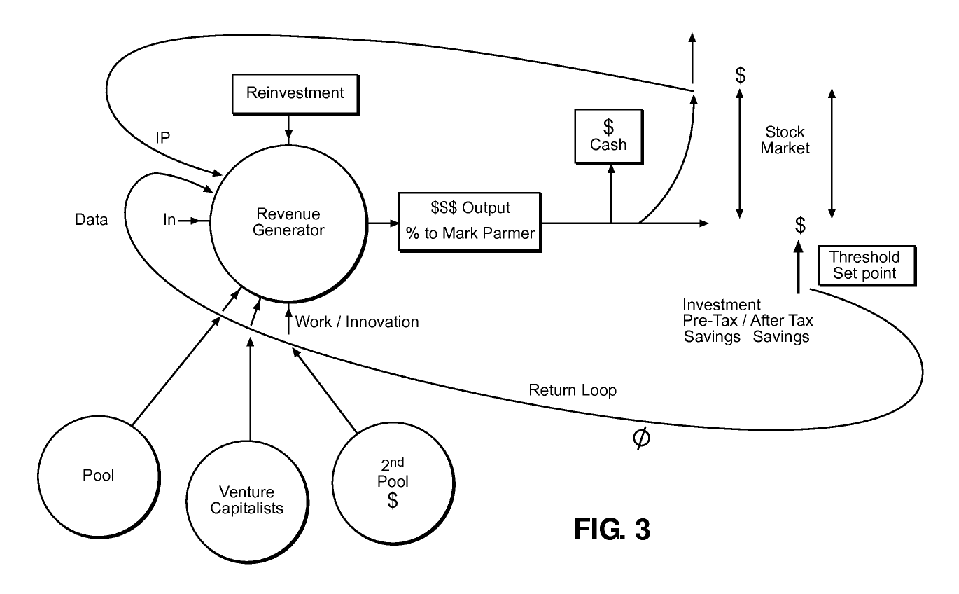

Referring now to FIGS. 2 and 3, there are shown diagrams of an exemplary embodiment of the investment process of the present invention. The investment is deposited into an investment account 201. The investment may be made in a variety of ways. Without limitation, investment may be made by trading in real estate, trading precious metals, purchasing a stock, making cash contributions, borrowing money, and the like. Additionally, the investment may be an annuity, 401K, Roth IRA, or a standard post-tax investment, but the focus will be on using the tax-deferred options of retirement accounts. After investment is made, the investor can own a percentage of the invention or a company derived therefrom. The investment can be rolled over, transferred to another account, or borrowed against for another intellectual property investment opportunity 202. If the investment is rolled over, transferred to another account, or borrowed against, the original investment is earmarked so that it can be subsequently returned to the investment account 204. In this way, the investors can avoid paying taxes until any earnings are withdrawn. Preferably, the investment is rolled over, transferred, or borrowed against if gains have been realized. If the gains are withdrawn, the gains may be taxable as they are considered to be earnings or profit. If gains have not been realized, investors can still roll over, transfer, or borrow against the original investment and add supplement funds. The original investment and any interest derived therefrom can be returned to the investment account after a predetermined period of time, or after the original investment has incurred a predetermined amount of gained or losses.

The investment account is continually monitored 203 in order to track gains and losses. If gains are realized 205, the original investment and/or the gained amount can be reinvested or looped into additional investments 207. For example, the investors can automatically reinvest on a 28-day cycle to keep the investing schedule as close to a calendar month as possible. In this way, the present system is self-propelled and perpetual. If gains are not realized or if the investment sustains losses, any remaining funds can be withdrawn 206 from the investment account to prevent further loss of funds. In some embodiments, the investor may be alerted when the remaining funds in the investment account falls below a predetermined threshold. As such, the present method prevents individuals from realizing even greater loss. The withdrawn investment can be traded for stock with equal or less value with growth potential in order to offset the loss. Alternatively, the investor may receive conversion rights to convert shares of preferred stock into shares of common stock, depending upon embodiment. In this way, the withdrawn investment can be later reinvested 208.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method for generating revenue by investing in intellectual property, comprising the steps of:
investing in an invention;
promoting said invention;
pairing at least one investor with a sponsoring company;
voting by proxy with a NAND gate system in order to make decisions; and
realizing gains or losses of an investment.

2. The method for generating revenue of claim 1, wherein said decisions comprise a decision to make improvements to said invention.

3. The method for generating revenue of claim 1, wherein said decisions comprise a decision to fund said invention.

4. The method for generating revenue of claim 1, wherein said decisions comprise a decision to manufacture said invention.

5. The method for generating revenue of claim 1, further comprising the steps of:
withdrawing said investment if losses have been realized.

6. The method for generating revenue of claim 5, wherein said investment is automatically withdrawn if losses exceed a predetermined threshold.

7. The method for generating revenue of claim 1, further comprising the steps of rolling over said investment to make a second investment if gains have been realized.

8. The method for generating revenue of claim 1, further comprising the steps of borrowing against said investment to make a second investment if gains have been realized.

9. The method for generating revenue of claim 1, wherein an original amount of said investment is earmarked.

10. The method for generating revenue of claim 1, wherein said sponsoring company provides a representative to assist said at least one investor.

11. The method for generating revenue of claim 1, wherein said at least one investor pays a fee to said sponsoring company.
